(19) United States
(12) Patent Application Publication
(10) Pub. No.: US 2016/0322674 A1
(43) Pub. Date: Nov. 3, 2016

(54) LARGE-CAPACITY ELECTRICAL ENERGY STORAGE DEVICE

(71) Applicant: AREVA, Courbevoie (FR)

(72) Inventor: Gilbert CAZENOBE, BAGNOLET (FR)

(73) Assignee: AREVA NP, Courbevoie (FR)

(21) Appl. No.: 15/105,281

(22) PCT Filed: Dec. 16, 2014
(86) PCT No.: PCT/EP2014/078002

§ 371 Date: Jun. 16, 2016

(30) Foreign Application Priority Data
Dec. 16, 2013 (FR) 13 62726

(51) Int. Cl. H01M 10/42; H02J 7/00; H01M 4/74; H01M 4/58; H01M 10/46; H01M 10/02

(52) U.S. Cl. CPC H01M 10/4235; H01M 10/46; H01M 10/02; H01M 4/747; H01M 4/58; H02J 7/0042; H02J 7/0052; H02J 2007/0059

(57) ABSTRACT

A large-capacity electrical energy storage device is provided. The electrical energy storage device includes a plurality of electrolytic cells and a four-quadrant charger/inverter. In each electrolytic cell, the negative electrode and the positive electrode are positioned opposite one another, the electrolytic cell comprising a device for rotating the negative electrode relative to the positive electrode around a rotation axis.

The present invention generally relates to electrical energy storage devices.

More specifically, the invention relates to an electrical energy storage device comprising a plurality of electrolytic cells and an electrical charger/inverter, each electrolytic cell comprising:
an anode compartment filled with an anode electrolyte comprising at least Fe3+ ions;
a positive electrode submerged in the anode electrolyte and electrically connected to a first terminal of the charger/inverter;
a cathode compartment filled with a cathode electrolyte comprising at least Fe2+ ions, the cathode compartment being separated from the anode compartment by a porous barrier;
a negative electrode submerged in the cathode electrolyte and electrically connected to a second terminal of the charger/inverter;
the charger/inverter being arranged to selectively either charge the storage device by circulating an electrical current in a first direction causing an iron deposit at the negative electrode, or deplete the storage device by allowing an electrical current to circulate in a second direction opposite the first causing a dissolution of the iron deposited at the negative electrode.

### BACKGROUND

Such an energy storage device is in particular known from CA 1,079,350.

### SUMMARY OF THE INVENTION

Electrical energy storage needs have increased considerably in recent years, in particular with the commissioning of intermittent renewable energy producing systems, such as wind turbine fields or photovoltaic cells. These systems produce at periods that do not correspond exactly to the consumption periods, resulting in the need to store the produced electrical energy during low-consumption periods so as to be able to have it during high-consumption periods.

In this context, an object of the invention is to provide a larger capacity energy storage device than that of CA 1,079,350.

To that end, the invention provides an energy storage device of the aforementioned type, characterized in that the negative electrode and the positive electrode are positioned opposite one another, the electrolytic cell comprising a device for rotating the negative electrode relative to the positive electrode around a rotation axis.

Thus, during charging of the storage device, the iron is deposited on the entire periphery of the negative electrode, as the latter passes across from the positive electrode. The iron is deposited on a large surface, regularly due to the rotational movement of the negative electrode. It is thus possible to increase the quantity of iron deposited in each electrolytic cell, and to increase the storage capacity of the electrical energy storage device, in proportion to the deposited mass.

The energy storage device may also have one or more of the features below, considered individually or according to all technically possible combinations.
the negative electrode has a cylindrical outer surface, coaxial to the rotation axis, on which the iron is deposited;
the positive electrode includes a part in the form of a cylinder sector, coaxial to the rotation axis;
the positive electrode is porous for the anode and/or cathode electrolyte, and defines the barrier between the anode compartment and the cathode compartment;
the positive electrode is made from titanium or sponge titanium or a titanium alloy;
the positive electrode is covered with a TiN coating;
the positive electrode is a fabric made from at least one interwoven wire, made from titanium or a titanium alloy;
the positive electrode is made from an electrically conductive material, covered with magnetite;
the electrolytic cell comprises:
   an anode electrolyte reservoir;
   an anode transfer device able to transfer the anode electrolyte between the anode electrolyte reservoir and the anode compartment;
   a cathode electrolyte reservoir;
   a cathode transfer device able to transfer the cathode electrolyte between the cathode electrolyte reservoir and the cathode compartment;
the rotation axis of the negative electrode is substantially horizontal, the cathode transfer device comprising a cathode electrolyte distribution ramp positioned above the negative electrode;
the device comprises a device provided to maintain a sky of the electrolytic cell under a neutral gas atmosphere, for example under argon pressure;
the sky of the electrolytic cell is kept at a pressure greater than the pressure around the electrolytic cell, preferably greater than 1 to 10 daPa at the pressure around the electrolytic cell;
the charger/inverter is arranged so as, during charging of the storage device, to temporarily reverse the circulation direction of the current; and
the charger/inverter is arranged so as, during charging of the storage device, to circulate an alternating current.

### BRIEF SUMMARY OF THE DRAWINGS

Other features and advantages of the invention will emerge from the following detailed description, provided for information and non-limitingly, in reference to the appended figures, in which:

FIG. 1 is a simplified diagrammatic illustration of an energy storage device comprising a large number of electrolytic cells, only some cells being shown; and

FIG. 2 is a simplified diagrammatic illustration of an electrolytic cell of the device of FIG. 1.

### DETAILED DESCRIPTION

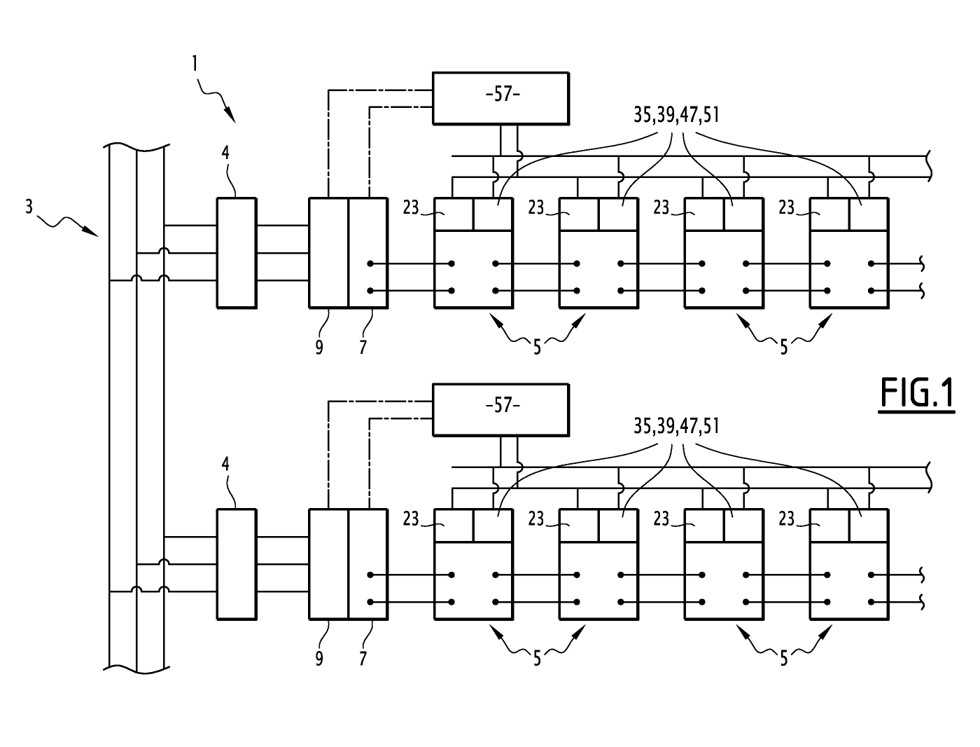

The device 1 shown in FIG. 1 is designed to store electrical energy. The device 1 is connected to an electrical energy distribution grid 3 via a power transformer 4. A certain number of electrical energy producing systems supply the grid 3 with electrical current. Electrical consumers are also connected to this grid.

The energy storage device 1 comprises a large number of electrolytic cells 5, and an electrical charger/inverter 7. Advantageously, it also includes a grid interface management system (GIMS) 9.

When the electrical power provided by the energy producing systems is greater than the power called for by electricity consumers, the energy storage device 1, notified by the GIMS 9, accumulates the excess energy, converting it in electrochemical form. Conversely, when the electrical power called for by consumers is greater than the power produced, the energy storage device 1, notified by the GIMS 9, converts the accumulated excess energy into electrical energy, which then supplies the grid 3.

Each electrolytic cell 5 for example makes it possible to store electrical energy of about 200 kWh. The electrolytic cells 5 are gathered in one or several sets, each set for example including 1300 electrolytic cells mounted in series, for an electrical energy storage capacity of about 300 MWh. Each electrolytic cell has a wattage rating of 20 kW A set therefore has a rated electrical power of about 30 MW.

The electrical charger/inverter 7 supplies all of the electrolytic cells 5 of a same set. Alternatively, the electrical charger/inverter 7 only supplies part of the electrolytic cells 5, the device 1 thus including several electrical chargers/inverters 7 for a same set.

Each electrical charger/inverter 7 is connected to the grid through the GIMS 9 and the power transformer 4. Preferably, each electrical charger/inverter 7 is of the so-called four-quadrant type.

The charger/inverter 7 is reversible. Thus, it operates as an inverter when the electrolytic cells 5 are depleted on the grid 3, and operates as a rectifier when, on the contrary, the electrolytic cells 3 are charged from the grid 3.

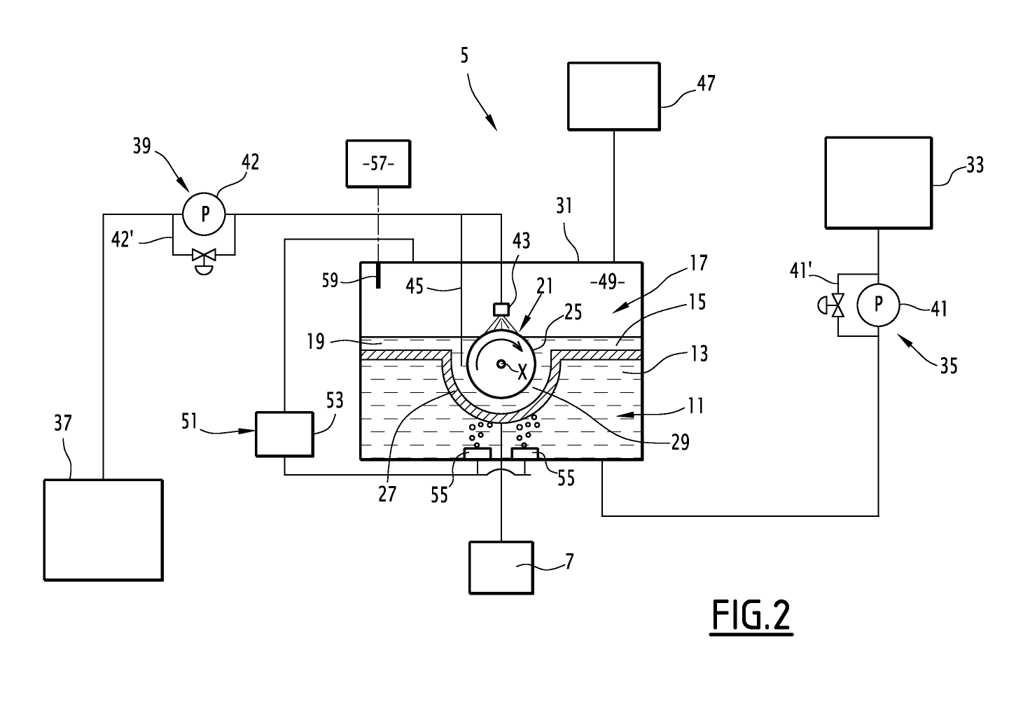

The electrolytic cells 5 are all identical, and are of the type shown diagrammatically in FIG. 2.

Alternatively, some of the electrolytic cells are not of the type shown in FIG. 2.

Each electrolytic cell 5 comprises:
an anode compartment 11 filled with an anode electrolyte 13;
a positive electrode 15 submerged in the anode electrolyte and electrically connected to a first terminal of the charger 7;
a cathode compartment 17 filled with a cathode electrolyte 19, the cathode compartment 17 being separated from the anode compartment 11 by a porous barrier;
a negative electrode 21 submerged in the cathode electrolyte 19 and electrically connected to a second terminal of the charger 7.

The electrochemical couple on the negative electrode side is Fe2+/Fe. The electrochemical couple on the positive electrode side is Fe2+/Fe3+.

More specifically, when the electrolytic cell 5 accumulates electrical energy, the following reaction occurs at the negative electrode:

Fe2++2e−→Fe

The following reaction occurs at the positive electrode:

2Fe2+→2Fe3++2e−

When the electrolytic cell 5 operates as an electrical generator, the following chemical reaction occurs at the negative electrode:

Fe→Fe2++2e−

The following reaction occurs at the positive electrode:

2Fe3++2e−→2Fe2+

In other words, the electrolytic cell 5 accumulates energy in an electrochemical form, storing that energy in the form of a solid iron deposit on the negative electrode and a Fe3+ solution. This iron deposit dissolves and the Fe3+ once again becomes Fe2+ when the cell 5 must give back electrical energy.

The charger/inverter 7 controls the circulation of the electrical current. When the electrolytic cell is on load, the charger/inverter 7 keeps the negative electrode at a negative electrical potential and the positive electrode at a positive potential greater in absolute value than that of the negative electrode. It therefore circulates the electrical current in a first direction, in particular causing an iron deposit at the negative electrode.

Conversely, when the electrolytic cell 5 operates as an electrical generator, the charger/inverter 7 keeps the negative electrode 21 at a potential lower than that of the positive electrode 15. The charger/inverter 7 therefore allows the current to circulate in a second direction opposite the first direction, causing the iron deposited on the negative electrode to dissolve and causing Fe2+ to form at the positive electrode.

The terms “positive electrode” and “negative electrode” are of course understood here according to standard IEC 600-50-482, CEI60050-482 dated Apr. 1, 2004.

The anode electrolyte 13 includes, inter alia, Fe3+ ions. It has an acid pH of about 2 and therefore includes about 10-2 M of H+. It also includes at least one anion, preferably Cl—. Alternatively, this anion is Br—, or any other appropriate anion, i.e., not participating in the reactions.

The cathode electrolyte 19 comprises Fe2+ ions. It has a pH of about 3 and therefore includes about 10-3 M of H+. It also includes at least one anion, for example Cl—. Alternatively, this anion is Br—, or any other appropriate anion, i.e., not participating in the reactions.

The anode electrolyte and the cathode electrolyte optionally include additives making it possible to increase the electrical conductivity without having action at the electrodes. These additives are traditional and will not be outlined here.

As shown in FIG. 2, the negative electrode 21 and the positive electrode 15 are positioned opposite one another, the electrolytic cell 5 including a device 23 (FIG. 1) for rotating the negative electrode 21 relative to the positive electrode 15 around a rotation axis X. The negative electrode 21 therefore rotates.

The negative electrode 21 and the positive electrode 15 are coaxial.

Thus, during charging of the storage device, the iron is deposited on the entire periphery of the negative electrode, as the latter passes across from the positive electrode. The iron is deposited on a large surface, regularly due to the rotational movement of the negative electrode. It is thus possible to increase the quantity of iron deposited in each electrolytic cell, and to increase the storage capacity of the energy storage device.

Typically, the negative electrode 21 has a cylindrical outer surface 25, coaxial to the rotation axis X, on which the iron is deposited when the electrolytic cell 5 operates as an electrical receiver. Alternatively, the negative electrode may have a non-cylindrical outer surface. This outer surface may be frustoconical, or may be in the shape of another surface of revolution around the axis X. The negative electrode 21 typically has a length comprised between 1.5 m and 4 m, and an outer diameter comprised between 20 cm and 1.5 m. In the present description, the numerical values correspond to an example embodiment in which the negative electrode has a length of 4 m and a diameter of 20 cm. According to another advantageous example, the negative electrode has a length of 1.5 m and an outer diameter of 1.5 m.

The negative electrode is made from a material with good electrical conduction, such as aluminum or steel.

As shown in FIG. 2, the positive electrode includes a cylindrical sector part 27, coaxial to the rotation axis X. The part 27 for example extends over about 180° around the axis X, and therefore forms a half-cylinder. A thin interstice 29 therefore separates the outer surface 25 of the negative electrode and the part 27 of the positive electrode. For example, the interstice 29 has a thickness comprised between 0.1 and 20 mm, preferably between 1 and 15 mm, and typically equal to 11 mm. A thickness of 11 mm makes it possible to obtain a storage capacity of 200 kWh per cell.

Alternatively, the cylindrical sector part 27 extends over more than 180° or less than 180° around the rotation axis X.

As also shown in FIG. 2, the electrolytic cell 5 includes a shell 31, the positive electrode 15 dividing the inner volume of the shell between an upper zone and a lower zone. The upper zone forms the cathode compartment 17. The lower zone forms the anode compartment 11. The latter is situated below the cathode compartment 17. The shell 31 is tight with respect to gas and liquids.

The positive electrode 15 has a porous structure for the anode electrolyte and the cathode electrolyte. It is also porous to gases.

The positive electrode 15 defines the porous barrier separating the anode compartment from the cathode compartment.

Typically, the positive electrode is made from titanium or a titanium alloy, and is for example a canvas or a foam. According to one alternative embodiment, the positive electrode is covered with a TiN coating, so as to increase the lifetime of the positive electrode and decrease the electrical losses.

In one example embodiment, the positive electrode is a fabric made from at least one interwoven wire, made from titanium or a titanium alloy. This fabric may be covered with TiN.

For example, the positive electrode is a metal grating sold by the company GANTOIS, under reference 104613. This grating is made with a T40 titanium wire, with a pre-weaving diameter of 0.8 mm. It is characterized by a metric number of 5, the mesh number being 4.57. The nominal opening of the fabric is 4.75 mm, and the transparency is 73%. The weight per unit area is 970 g/m². The fabric has a thickness comprised between 1.4 and 1.6 mm. This grating may be covered with TiN.

According to another example embodiment, the positive electrode is a metal canvas sold by the company GANTOIS, under reference 104125. This fabric is obtained from T40 titanium metal wires, the warp yarn having a pre-weaving diameter of 0.36 mm and the weft yarn having a pre-weaving diameter of 0.265 mm. The wire bears a metric number of 22 for the warp yarn and 230 for the weft yarn. The weight per unit area is 2400 g/m² and the fabric has a nominal opening of 0.180 mm. This canvas may be covered with TiN.

According to one embodiment, the positive electrode is made from sponge titanium. Sponge titanium is an intermediate product in titanium metallurgy. It may be covered with TiN.

In one very cost-effective alternative embodiment, the positive electrode 15 is made from an electrically conductive material, covered with magnetite. Fe3O4. For example, the positive electrode is made from steel-faced copper, which is then partially electrolytically oxidized into Fe3O4.

The electrolytic cell 5 further includes:
an anode electrolyte reservoir 33,
an anode transfer device 35 able to transfer the anode electrolyte between the anode electrolyte reservoir 33 and the anode compartment 11;
a cathode electrolyte reservoir 37;
a cathode transfer device 39 able to transfer the cathode electrolyte between the cathode electrolyte reservoir 37 and the cathode compartment 17.

The anode transfer device 35 typically includes a transfer member 41, for example a pump, connected on one side to the reservoir 33 and on the other side to the anode compartment 11.

In the example shown in the figures, the anode electrolyte reservoir 33 is situated at an elevation higher than that of the cell 5. The anode transfer device 35 includes a bypass 41′, placing the reservoir 33 in communication with the anode compartment while bypassing the transfer member 41. The bypass 41′ is equipped with a controlled valve, making it possible to selectively close off or open the bypass.

When the electrolytic cell is on load, the transfer member 41 takes the anode electrolyte from the anode compartment 11 and discharges it into the reservoir 33. The bypass 41′ is closed off.

Conversely, when the electrolytic cell operates as an electrical generator, the transfer member 41 is stopped. The bypass 41′ is open. The anode electrolyte flows by gravity and/or by siphon effect from the reservoir 33 to the inside of the anode compartment, through the bypass 41′.

Likewise, the cathode transfer device 39 includes a reversible transfer member 42, for example a pump, connected on one side to the reservoir 37 and on the other side to the cathode compartment 17.

In the example shown in the figures, the cathode electrolyte reservoir 37 is situated at an elevation lower than that of the cell 5. The cathode transfer device 39 includes a bypass 42′, placing the reservoir 37 in communication with the cathode compartment while bypassing the transfer member 42. The bypass 42′ is equipped with a controlled valve, making it possible to selectively close off or open the bypass.

When the electrolytic cell is on load, the transfer member 42 takes the cathode electrolyte from the reservoir 37 and discharges it into the cathode compartment 17. The bypass 42′ is closed off.

Conversely, when the electrolytic cell operates as an electrical generator, the transfer member 42 is stopped. The bypass 42′ is open. The cathode electrolyte flows by gravity and/or by siphon effect from the cathode compartment 17 to the inside of the reservoir 37.

Alternatively, the transfer members 41 and 42 are reversible. The anode and cathode transfer devices 35 and 39 do not include bypasses 41′, 42′. The pump 41 is used to transfer the anode electrolyte from the reservoir 33 into the anode compartment 13. The pump 42 is used to transfer the cathode electrolyte from the cathode compartment 15 into the reservoir 37.

As illustrated in FIG. 2, in one particularly advantageous embodiment, the rotating negative electrode has a substantially horizontal rotation axis X. The negative electrode 21 is only partially submerged in the cathode electrolyte filling the compartment 17. In this case, the cathode transfer device includes a distribution ramp 43 situated above the negative electrode 21. Typically, the distribution ramp 43 extends along the generatrix situated at the highest point of the outer surface 25 of the negative electrode.

The distribution ramp 43 is pierced with a plurality of orifices through which the cathode electrolyte discharged by the transfer member 41 flows, and falls on the outer surface 25. Thus, the fresh cathode electrolyte brought in by the transfer device 39 is distributed uniformly over the entire outer surface 25.

In this embodiment, the transfer device 39 comprises a submerged withdrawal pipe 45, one end of which is continuously submerged in the cathode electrolyte filling the chamber 17. The ramp 43 is used when the transfer device discharges the cathode electrolyte from the reservoir 37 into the cathode chamber 17. The submerged pipe 45 is used when the cathode electrolyte circulates in the opposite direction, from the chamber 17 toward the cathode electrolyte reservoir 37.

In one embodiment that is not shown, the negative electrode 21 is completely submerged in the cathode electrolyte. The distribution ramp 43 is also submerged in the cathode electrolyte and extends along the generatrix situated at the highest point of the outer surface 25. In this case, the ramp 43 is used to suction the cathode electrolyte when the latter circulates from the chamber 17 toward the cathode electrolyte reservoir 37. The transfer device 39 does not include a submerged withdrawal pipe 45.

Alternatively, the rotation axis X of the negative electrode is vertical. This alternative is advantageous because it greatly reduces the footprint of each electrolytic cell.

Furthermore, the electrolytic cell 5 also includes a device 47 provided to keep the sky 49 of the electrolytic cell under a neutral gas atmosphere. A neutral gas here refers to a gas that does not participate in the chemical and electrochemical reactions that take place in the device, and does not modify the composition of the materials making up the device.

The neutral gas is preferably argon. Alternatively, the neutral gas is nitrogen, or another neutral gas, or a mixture of neutral gases.

The device 47 for example includes a pressurized gas reserve connected to the sky 49 of the electrolytic cell via a line equipped with an expander.

According to another example embodiment, the device 47 includes a neutral gas reserve and a compressor discharging the neutral gas from the reserve into the sky 49 of the electrolytic cell.

The sky 49 of the electrolytic cell is kept at a pressure slightly higher than the pressure around the electrolytic cell, so as to prevent the oxygen from the air from penetrating inside the electrolytic cell. For example, the sky 49 is kept at a pressure slightly higher than the atmospheric pressure, from 1 to 10 relative daPa.

In the example embodiment shown in FIG. 2, the anode compartment 11 is completely filled with anode electrolyte, while the cathode compartment 17, which is situated above the anode compartment 11, is only partially filled with electrolyte. The sky 49 corresponds to the fraction of the cathode compartment that is not filled with the cathode electrolyte 19 and that is filled with the neutral gas or gases.

The electrolytic cell 5 also includes a device 51 for recycling gaseous hydrogen given off in the cathode compartment 17.

Indeed, hydrogen is given off in the cathode compartment, essentially during charging. The gaseous hydrogen ends up in the sky 49 of the electrolytic cell.

The device 51 comprises a circulation member 53, for example a pump for the gases, the suction of which communicates with the sky 49, and the discharge of which communicates with the anode compartment 11. The circulation member 53 discharges the gaseous phase occupying the sky 49 toward a zone of the anode compartment 11 situated below the positive electrode, as shown in FIG. 2. Preferably, said zone is situated in immediate contact with the positive electrode. Thus, the gaseous phase discharged by the member 53 will form bubbles that will rise toward the sky 49 while crossing through the positive electrode 15. While passing through the porous positive electrode 15, the gaseous hydrogen molecules are oxidized in H+ according to the half-reaction H2□2H++2e−.

The recirculation rate imposed by the device 51 is adjusted as a function of the observed release of gaseous hydrogen, so as to guarantee the absence of gaseous hydrogen in the sky 49 during periods situated between the charging and discharging of the electrolytic cell 5. For example, the recirculation rate is comprised between 50 and 500 l/h, preferably between 100 and 200 l/h, typically approximately 160 l/h. During the discharge period, the recirculation is generally not necessary.

Typically, the device 51 comprises one or several ramps distributed below the positive electrode 15, in the anode compartment 11. The member 53 discharges the gas toward the ramps 55. The ramps 55 have orifices dividing the gas into very fine bubbles. The recycle gas is thus uniformly distributed inside the anode compartment in order to oxidize it completely.

The device 1 also includes a control automatism 57 (FIG. 1), provided to simultaneously control the rotational driving device 23 of the negative electrode, the anode transfer device 35, the cathode transfer device 39, the device 47 keeping the sky of the electrolytic cell under a neutral gas atmosphere, and the device 51 for recycling gaseous hydrogen. The control automatism 57 also controls the electrical charger/inverter 7 and exchanges data with the GIMS 9.

Advantageously, the recycling device 51 comprises a probe 59 for measuring the hydrogen concentration in the gaseous phase filling the sky 49 of the electrolytic cell. This probe provides information to the automatism 57. This automatism is programmed to control the recycling device 51 as a function of the hydrogen concentration measured by the probe.

The operation of the energy storage device will now be outlined.

It is assumed here that all of the electrolytic cells 5 are controlled in the same way. Only the operation of one cell will be described below.

As indicated above, when the electrolytic cell is on load, i.e., is accumulating electrical energy, the charger/inverter 7 keeps the negative electrode 21 at a negative polarity and the positive electrode 15 at a positive polarity.

The device 39 supplies the cathode compartment 17 with cathode electrolyte from the reservoir 37. In the example of FIG. 2, the cathode electrolyte is discharged by the member 42 toward the ramp 43 and flows over the generatrix situated at the apex of the outer surface 25 of the negative electrode 21.

The anode transfer device 35 bleeds the electrolyte in the anode compartment 11 to transfer it to the anode reservoir 33.

The device 47 keeps the sky 49 under neutral gas pressure. The negative electrode 21 is rotated by the driving device 23.

Some of the Fe2+ ions of the cathode electrolyte 19 are reduced into Fe and are deposited on the outer surface 25 of the rotating negative electrode 21. Furthermore, under the effect of the bleeding done by the transfer device 35, the cathode electrolyte crosses through the porous positive electrode 15 until reaching the anode compartment 11. Upon crossing through the positive porous electrode 15, the rest of the Fe2+ ions are oxidized into Fe3+ ions. The addition of fresh cathode electrolyte and the bleeding of the anode electrolyte make it possible to keep the cathode electrolyte composition and the anode electrolyte composition substantially constant over time, despite the iron deposit on the negative electrode.

Furthermore, the probe 59 continuously polls the hydrogen concentration in the gaseous phase. The control automatism 57, depending on the measured hydrogen concentration, commands the gaseous hydrogen recycling device 51 to withdraw part of the gaseous phase in the sky 49. The device 51 reinjects it below the positive electrode 15, in the anode compartment. This gaseous phase essentially comprises the neutral gas, and traces of hydrogen. This reinjected gaseous phase forms bubbles that rise through the anode compartment 11 to the porous positive electrode 15. In contact with the porous positive electrode, the gaseous hydrogen H2 is oxidized in H+ ions.

Advantageously, the charger/converter 7 is controlled periodically to temporarily reverse the circulation direction of the current. This causes a small fraction of the iron deposit on the negative electrode to dissolve again, and prevents the creation of large crystals on the negative electrode. During the circulation of the current in the opposite direction, the anode and cathode electrolyte circulation is interrupted.

These crystals indeed could create reliefs on the surface of the negative electrode, which could come into contact with the positive electrode, interrupt the charge of the electrolytic cell, and therefore decrease its capacity.

For example, the charger/converter 7 is controlled to cause an alternating current to circulate to that end. Typically, the ratio between the quantity of cathode current and the quantity of anode current is comprised between 5 and 10.

When the electrolytic cell is operating as an energy generator, the negative electrode 21 has a negative polarity and the positive electrode 15 has a positive polarity. The device 47 keeps the sky 49 of the electrolytic cell under neutral gas pressure. The cell 5 supplies the charger/inverter 7. The hydrogen recycling device 51, during this phase, is generally kept stopped by the control automatism 57, since there is normally no release of gaseous hydrogen.

The transfer device 35 takes the anode electrolyte from the reservoir 33 and transfers it into the anode compartment 11. The transfer device 39 takes the cathode electrolyte from the cathode compartment 17, for example via the submerged pipe 45, and transfers it into the cathode reservoir 37.

The driving device 23 rotates the negative electrode 21 at a speed depending on the current called for.

Under the effect of the anode electrolyte injection in the anode compartment 11, the electrolyte crosses through the porous positive electrode 15. During passage, the Fe3+ ions are reduced into Fe2+. At the negative electrode 21, the iron previously deposited is oxidized into Fe2+.

What is claimed is:

1-14. (canceled)

15. An electrical energy storage device comprising a plurality of electrolytic cells and an electrical charger/inverter, each electrolytic cell comprising:
an anode compartment filled with an anode electrolyte comprising at least Fe³⁺ ions;
a positive electrode submerged in the anode electrolyte and electrically connected to a first terminal of the charger/inverter;
a cathode compartment filled with a cathode electrolyte comprising at least Fe²⁺ ions, the cathode compartment being separated from the anode compartment by a porous barrier;
a negative electrode submerged in the cathode electrolyte and electrically connected to a second terminal of the charger/inverter; and
a rotator configured for rotating the negative electrode relative to the positive electrode around a rotation axis, the charger/inverter being arranged to selectively either electrically charge the storage device by circulating an electrical current in a first direction causing an iron deposit at the negative electrode, or electrically deplete the storage device by allowing an electrical current to circulate in a second direction opposite the first direction causing a dissolution of the iron deposited at the negative electrode, the negative electrode and the positive electrode being positioned opposite one another.

16. The device according to the claim 15 wherein for each of the electrolytic cells the negative electrode has a cylindrical outer surface, coaxial to the rotation axis, on which the iron is deposited.

17. The device according to the claim 15 wherein for each of the electrolytic cells the positive electrode includes a part in the form of a cylinder sector, coaxial to the rotation axis.

18. The device according to the claim 15 wherein for each of the electrolytic cells the positive electrode is porous for the anode and/or cathode electrolyte, and defines the barrier between the anode compartment and the cathode compartment.

19. The device according to the claim 15 wherein for each of the electrolytic cells the positive electrode is made from titanium or sponge titanium or a titanium alloy.

20. The device according to the claim 15 wherein for each of the electrolytic cells the positive electrode is covered with a TiN covering.

21. The device according to the claim 15 wherein for each of the electrolytic cells the positive electrode is a fabric made from at least one interwoven wire, made from titanium or a titanium alloy.

22. The device according to the claim 15 wherein for each of the electrolytic cells the positive electrode is made from an electrically conductive material, covered with magnetite.

23. The device according to the claim 15 wherein each of the electrolytic cells further comprises:
an anode electrolyte reservoir;
an anode transferer configured to transfer the anode electrolyte between the anode electrolyte reservoir and the anode compartment;
a cathode electrolyte reservoir; and
a cathode transferer configured to transfer the cathode electrolyte between the cathode electrolyte reservoir and the cathode compartment.

24. The device according to the claim 23 wherein for each of the electrolytic cells the rotation axis of the negative electrode is substantially horizontal, the cathode transferer comprising a cathode electrolyte distribution ramp positioned above the negative electrode.

25. The device according to the claim 15 further comprising a sky maintainer for each of the electrolytic cells configured to maintain a sky of one of the electrolytic cell under a neutral gas atmosphere.

26. The device according to the claim 25 wherein for each of the electrolytic cells the sky of the electrolytic cell is kept at a pressure greater than the pressure around the electrolytic cell.

27. The device according to the claim 15 wherein the charger/inverter is arranged so as, during charging of the storage device, to temporarily reverse the circulation direction of the current.

28. The device according to the claim 15 wherein the charger/inverter is arranged so as, during charging of the storage device, to circulate an alternating current.
